(19) United States
(12) Patent Application Publication
(10) Pub. No.: US 2016/0258827 A1
(43) Pub. Date: Sep. 8, 2016

(54) METHOD FOR DETERMING A TRANSITION POINT AND/OR FOR DETERMINING WALL SHEAR STRESSES ON SURFACES AROUND WHICH SURFACES A FLOW CIRCULATES, AND MEASURING DEVICE

(71) Applicant: MTU AERO ENGINES AG, München (DE)

(72) Inventors: Martin Stadlbauer, Munich (DE); Jurgen Grundmayer, Starnberg (DE); Felix Von Plehwe, Meerbusch (DE)

(73) Assignee: MTU Aero Engines AG, Munich (DE)

(21) Appl. No.: 14/897,444

(22) PCT Filed: Jun. 10, 2014
(86) PCT No.: PCT/DE2014/000294

§ 371 Date: Mar. 22, 2016

(30) Foreign Application Priority Data
Jun. 14, 2013 (DE) 10 2013 211 119.3

(51) Int. Cl. G01L 1/24; G01N 25/72; G01J 5/10

(52) U.S. Cl. CPC G01L 1/241; G01J 5/10; G01N 25/72; G01J 2005/0085

(57) ABSTRACT

The invention relates to a method for determining a transition point and/or for determining wall shear stresses on surfaces (1) around which surfaces a flow circulates by means of thermography, wherein the method comprises the following steps: providing a surface with a heat insulation layer (3) on the surface (1) around which a flow is to circulate, circulating a flow around the surface (1) around which a flow is to circulate, heating the surface (1) around which a flow circulates, contactless measuring of the emitted flow intensity of the surface (1) around which a flow circulates by means of a camera system (7), determining at least one temperature decay coefficient on the surface (1) around which a flow circulates and ascertaining the transition point and/or the wall shear stresses on the surface (1) around which a flow circulates.

The present invention relates to a method for determining a transition point and/or for determining wall shear stresses on surfaces around which a flow circulates according to claim 1. The present invention further relates to a measuring device according to claim 12.

Of importance for understanding flow processes on bodies around which a flow circulates is to determine the transition point between laminar and turbulent flow by means of measurements. Employed for this purpose, among other things, is so-called hot-film anemometry, which, for example, determines the transition point along a line of a body around which a flow circulates. The wall shear stress can be determined by means of hot-film anemometric measurements and an appropriate calibration.

An object of the present invention is to propose a novel contactless method for determining a transition point and/or for determining wall shear stresses at surfaces around which a flow circulates. It is another object of the present invention to propose a corresponding measuring device.

The object according to the invention is achieved by a method having the features of claim 1. It is further achieved by a measuring device having the features of claim 12.

Accordingly, in accordance with the invention, a method for determining a transition point on surfaces around which a flow circulates by means of thermography is proposed. Additionally or alternatively, the method can be used for determining wall shear stresses on surfaces around which a flow circulates.

A transition point generally describes the turnaround point from a laminar flow to a turbulent flow or from a turbulent flow to a laminar flow, in particular along a surface, in space, or along a line. The transition point is also referred to as the instability point of the flow.

Thermography describes an imaging method for measuring and/or indicating a temperature, in particular the surface temperature, of objects. In this process, the intensity of an infrared beam that is emitted from one point or from one surface of the object, for example, is taken as a measure of the temperature thereof.

For the determination of the transition point and/or the wall shear stresses, the method according to the invention comprises the following steps: providing a surface with a heat insulation layer on the surface on which the flow is to circulate or around which the flow is to circulate (in short, around which the flow circulates), circulating a flow on or around the surface (in short, circulating a flow around the surface) around which the flow is to circulate, heating the surface around which the flow circulates, contactless measurement of the emitted heat of the surface around which the flow circulates by means of a camera system, determining at least one temperature decay coefficient on the surface around which the flow circulates, and determining the transition point and/or the wall shear stresses on the surface around which a flow circulates or qualitatively visualizing or representing the heat transfer into the flow.

The measuring device according to the invention is provided, set up, and/or configured for determining the transition point and/or for determining the wall shear stresses on surfaces around which a flow circulates. The measuring device is further configured to perform at least one of the following method steps: heating the surface around which a flow circulates, contactless measurement of the emitted heat of the surface around which a flow circulates by means of a camera system, determining at least one temperature decay coefficient on the surface around which a flow circulates, and determining the transition point and/or the wall shear stresses on the surface around which a flow circulates. It has the required devices in each case for this purpose.

In all preceding and following statements, the use of the expression “can be” or “can have,” etc. is to be understood synonymously to mean “is preferably” or “has preferably,” etc. and is intended to explain embodiments according to the invention.

Advantageous enhancements of the present invention are the subject of each of the dependent claims and embodiments.

Embodiments according to the invention can have one or more of the features mentioned in the following.

The term “heat insulation layer,” as used herein, refers to a layer having low thermal conduction properties. A measure of the thermal conduction in a material or a substance is the thermal conductivity of the material or of the substance. The thermal conductivity is a material property.

A heat insulation layer can be referred to as a layer having poor thermal conduction properties. If, for example, a surface of a heat insulation layer is heated by means of a heat source (for example, by thermal radiation), then the heat is further transmitted from this heat insulation layer to only a small extent (or on the surface to only a small extent).

In general, there is no limitation of the thermal conductivity. However, it has been found to be advantageous when the thermal conductivity of the insulation layer is smaller than the thermal conductivity of the base material by a factor of at least 5.

For example, epoxide resin lacquer of, for example, 100 μm can be used as a heat insulation layer.

In some embodiments according to the invention, the heat insulation layer has a thickness of several micrometers (μm)—for example, between 0.1 μm and 500 μm.

A heat insulation layer can also be referred to as a thermal insulating layer.

In some embodiments according to the invention, the heat insulation layer is applied to the face of the surface around which a flow is to circulate and is thereby provided. For example, the heat insulation layer can be applied in a detachable or non-detachable manner to the surface and fixed in place, in particular by adhesive bonding. Alternatively, the heat insulation layer can be applied by lacquering, vapor deposition, mechanical fastening, welding (for example, by means of point welding), soldering, and clamping. Combinations of the fastening variants mentioned are also possible in accordance with the invention.

In certain embodiments according to the invention, the surface around which a flow circulates is already provided beforehand in finished form with the heat insulation layer on the surface. For example the heat insulation layer can be produced with the surface around which a flow is to circulate at another location under special fabrication conditions (for example, under vacuum).

In some embodiments according to the invention, an active flow is circulated around the surface around which a flow is to circulate. The term “active,” as used herein, refers to a flow that is directed directly onto the surface around which a flow is to circulate, as is the case, for example, for a model in a wind tunnel, in which the flow is directed onto the model in order to study certain flow phenomena. The model can be, for example, an airplane having wing profiles, a stator blade in a turbine, or an automobile model for determination of air resistance.

In some embodiments according to the invention, a passive flow is circulated around the surface around which a flow is to circulate. The term “passive,” as used herein, refers to a flow that is forced to flow around a profile, because the profile itself is moved. This occurs, for example, for a rotor blade (or impeller) in a gas turbine, which is subjected to a circulating flow, because the rotor blade itself is moved (set in rotation).

In certain embodiments according to the invention, the surface around which a flow circulates is heated, in particular heated for a short time.

In some embodiments according to the invention, the heating of the surface around which a flow circulates occurs on the free face of the heat insulation layer, that is, on the side of the heat insulation layer that is not directly joined to the surface around which a flow circulates.

In certain embodiments according to the invention, the contactless measurement of heat emitted from the surface around which a flow circulates is conducted by means of a camera system, in particular by means of an infrared camera system. An infrared camera is also referred to as a thermal imaging camera or as a thermographic camera.

In some embodiments according to the invention, the emitted heat of the surface around which a flow circulates is measured by contactless area measurement. Here, area measurement is understood to mean a measurement that does not create an area measurement in steps by means of a point-like or line-shaped measurement or scanning (as, for example, in the so-called line scanning method), but rather a measurement that records the surface to be measured in a single measurement. This area measurement can be referred to as a full-face measurement.

In some embodiments according to the invention, the heat emitted by the face around which a flow circulates is measured spatially and/or two-dimensionally on the face in a contactless manner.

In certain embodiments according to the invention, at least one temperature decay coefficient on the surface around which a flow circulates is determined. In particular, the temperature decay coefficient can be determined at each location (synonymously to: at each point) on the face and/or it can be determined by surface area measurement.

The temperature decay coefficient can be proportional to or can be assumed to be proportional to the heat transfer coefficient.

In some embodiments according to the invention, the transition point is determined and/or the wall shear stresses are determined on the surface around which a flow circulates after the temperature decay coefficient has been determined on the surface around which a flow circulates. In other words, the transition point is determined and/or the wall shear stresses are determined on the surface around which a flow circulates based on the determination of the temperature decay coefficient.

In certain embodiments according to the invention, the face of the heat insulation layer has a functional layer applied to the face. For example, the face can have a layer with a color of high emissivity (synonymously to: color with a high degree of emission) as the functional layer. The term “degree of emission” or “emissivity” of a body, as is used herein, indicates how much (thermal) radiation the body emits in comparison to an ideal thermal radiator, a so-called black body. For example, polished iron has a low emissivity of approximately ε_{N}=0.1 (the emissivity ε_{N} of a body can be given as the ratio of the specific radiance from a unit area of the body to the radiation density emitted from a black body of the same temperature).

The emissivity should be as high as possible in the relevant wavelength range and/or at the relevant thermal conductivity—for example, ε_{N}≧0.6.

In some embodiments according to the invention, it is possible through the application of the functional layer to detect in an advantageous manner the emitted heat of the surface around which a flow circulates with a higher signal-to-noise ratio in comparison to a surface around which a flow circulates, but without a functional surface, by means of the camera system.

In certain embodiments according to the invention, reference values of the emitted heat of the surface around which a flow circulates are determined by means of the camera system, whereby, in the determination of the reference values, no circulation occurs around the surface around which a flow is to circulate. Accordingly, in the determination of the reference values, the following steps, in particular, are carried out: providing a face with a heat insulation layer on the surface around which a flow is to circulate, heating of the face, contactless measurement of the radiation intensity emitted in a λ range (λ=wavelength) of the face over time by means of a camera system, determining at least one temperature decay coefficient on the surface.

In some embodiments according to the invention, temperature decay constants on the surface around which a flow circulates are determined, whereby reference values are deducted (or subtracted) from the measured values or vice versa (that is, the measured values are subtracted from the reference values). The measured values relate here to the radiation intensity emitted from the surface around which a flow is to circulate during circulation around this surface. It is possible by means of this subtraction to advantageously prevent errors in measurement due to different local emission coefficients and thermal conductivities as well as due to inhomogeneous illumination onto the face. In this way, it is possible to image or effectively measure only the heat transfer into the flow itself; heat transport phenomena into the material of the surface around which a flow circulates and/or into the heat insulation layer play no role or only a subordinate role.

In certain embodiments according to the invention, the surface around which a flow circulates is a surface of a turbine rotor blade. A turbine rotor blade can be a rotor blade of a high-pressure turbine stage and/or a low-pressure turbine stage of a turbine. The turbine rotor blade can further be a rotor blade of a high-pressure compressor stage and/or a low-pressure compressor stage of a turbine.

In some embodiments according to the invention, the surface around which a flow circulates is a surface of a turbine stator blade. A turbine stator blade can be a stator blade of a high-pressure turbine stage and/or a low-pressure turbine stage of a turbine. The turbine stator blade can further be a stator blade of a high-pressure compressor stage and/or a low-pressure compressor stage of a turbine.

In certain embodiments according to the invention, the camera system is an infrared camera system or has such an infrared camera system. An infrared camera system can be referred to as a thermal imaging camera system, as a thermographic camera system, as a thermal camera system, or as a thermal imaging device.

In some embodiments according to the invention, the infrared camera is combined with a boroscope or has a boroscope. Further synonymous terms for boroscope are: borescope, endoscope, technoscope, autoscope, or intrascope. For applications in turbines, it is possible by means of a boroscope (for example, an infrared boroscope) or other optics to measure the decay behavior of the heat emitted from previously heated rotor surfaces around which a flow circulates over a number of rotations of the rotor and beyond.

In some embodiments according to the invention, the surface around which a flow circulates is heated by means of a flash lamp or by means of a laser. It is possible by means of a flash lamp or by means of a laser to heat the surface around which a flow circulates with or without circulation of a flow around the surface within a short period of time (briefly). It is possible by means of special rapid infrared cameras (for example, so-called indium antimonide (InSb) “focal plane array” (FPA) cameras with an image repetition or frame rate of around 800 images per second and integration times of less than 1 μs) to record the temperature decay behavior of the face over the entire surface and to determine the decay constants for each location on or over the face.

In certain embodiments according to the invention, the heating (for example, by means of a flash lamp or laser), the contactless measurement of the emitted heat, and the determination of the temperature decay coefficient is repeated at least a second time, in order to further optimize the signal-to-noise ratio by, for example, averaging the measurement results. Additional measurements can further optimize the signal-to-noise ratio.

In certain embodiments according to the invention, the wall shear stresses are determined by means of previously determined temperature decay coefficients. The correlation between the wall shear stresses and the temperature decay coefficients are based on the relation explained in the following. The temperature decay coefficients are proportional to the heat transfer coefficients. Furthermore, for incompressible flows, the so-called Reynolds analogy applies, which states that the impulse transfer and heat transfer are similar for flows subject to friction. Consequently, it is possible on the basis of a heat transfer measured by means of an infrared camera system, for example, to determine the impulse transfer. It is possible by means of the impulse transfers to determine the wall shear stresses. Accordingly, the method according to the invention can be used to carry out contactless full-surface measurement of wall shear stress or quasi wall shear stress. Furthermore, it is possible to accomplish a simple visualization (quantitative) of the heat transfer into the flow.

In certain embodiments according to the invention, the emitted heat of the surface around which a flow circulates is measured on the flow side of the surface around which a flow circulates.

In some embodiments according to the invention, the measuring device for determining a transition point and/or for determining wall shear stresses on surfaces around which a flow circulates is configured for carrying out the following method steps: heating of the surface around which a flow circulates, contactless measurement of the emitted heat of the surface around which a flow circulates by means of a camera system, determining at least one temperature decay coefficient on the surface around which a flow circulates, and determining the transition point and/or the wall shear stresses on the surface around which a flow circulates.

In certain embodiments according to the invention, the transition point is determined and/or the wall shear stresses are determined on the surface around which a flow circulates by analysis of the measurement data of the contactless measurement of the emitted heat and/or of the at least one temperature decay coefficient. An analysis can include a comparison with other measurement data that was recorded earlier, for example, or with measurement data from tables or other comparison data (or reference data). An analysis can include a comparison with process data of earlier measurements. It is possible on the basis of this analysis to determine the transition point and/or the wall shear stresses on the surface around which a flow circulates.

In some embodiments according to the invention, the transition point is determined and/or the wall shear stresses are determined on the surface around which a flow circulates by using a comparison device to compare the measurement data of the contactless measurement of the emitted heat and/or the at least one temperature decay coefficient with additional data.

In some embodiments according to the invention, the measuring device is a test bench. The measuring device can include an analysis unit for the measurement results.

Some or all embodiments according to the invention can have one or more or all of the advantages mentioned above and/or below.

An advantage of a heat insulation layer on the surface around which a flow is to circulate consists in the fact that heating supplied suitably from the outside onto one surface side of the heat insulation layer does not continue or continues at least only to a small extent to the other surface side, in particular not to the side that is joined directly to the surface around which a flow circulates. Accordingly, it is possible to advantageously prevent the heat supplied from the outside from heating the surface lying below the heat insulation layer and around which a flow circulates or at least from not heating it appreciably. Consequently, no heat or, at most, only a small portion thereof, is further transmitted by means of heat conduction (synonymously to: thermal conduction) in the portion around which a flow circulates and which would not be available for the method of measurement with a camera system according to the invention.

Another advantage of the heat insulation layer is the better local resolution that can be achieved in the contactless measurement of the emitted heat of the surface around which a flow circulates. This better local resolution therefore results from the fact that the heat remains localized, is not spread out, and is not further conducted onto the face by means of thermal conduction or is not distributed over the surface area or at least is distributed only to a smaller extent.

It is possible by means of a heat insulation layer on a surface around which a flow is to circulate, such as, for example, a blade, to achieve a high contrast in the measurement of the emitted heat.

By means of a heat insulation layer, the quantitative calculation of a heat transfer coefficient can be markedly less prone to error.

The present invention will be explained below on the basis of the attached drawing. The following applies to the schematically simplified, single FIGURE:

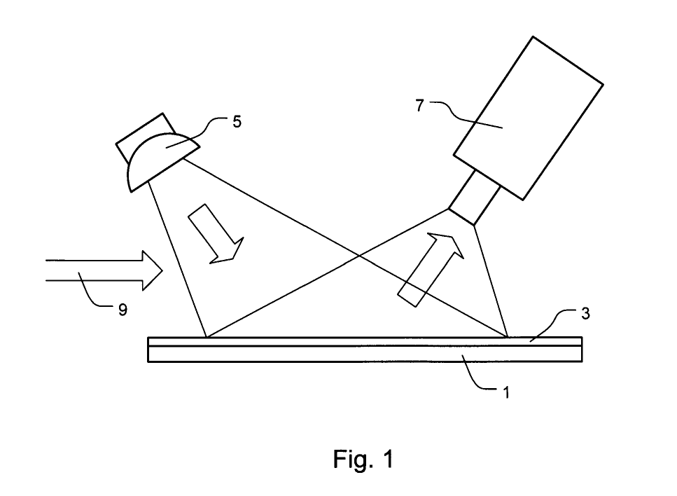

FIG. 1 shows a side view of a surface around which a flow circulates, which has a heat insulation layer and is heated by means of a flash lamp, and a camera system.

FIG. 1 shows a side view of a surface 1 around which a flow circulates, with a heat insulation layer 3 that is joined to it over its surface area, which is heated by means of a flash lamp 5. Further illustrated in simplified manner is a camera system 7, which records the heat emitted by the heat insulation layer 3 in a contactless manner.

It is possible by means of the heat insulation layer 3, on the one hand, to prevent at least for the most part a portion of the heat from being further transmitted into the surface 1 around which a flow circulates. On the other hand, the heat on or along the face of the heat insulation layer 3 is not further transmitted or distributed. Accordingly, owing to the heat insulation layer 3, it is possible to achieve a high contrast in the contactless measurement of the emitted heat. Furthermore, owing to the heat insulation layer 3, the quantitative calculation of the heat transfer coefficient is appreciably less prone to error.

The camera system 7 can be, for example, an infrared system with a high image repetition or frame rate (for example, around 800 images per second) and short integration times (of less than 1 μs). Such an infrared camera system can record the temperature decay behavior of the face of the heat conduction layer 3, which is joined to the surface 1 around which a flow circulates, over its full surface area, and the decay constants can be determined for each location on the surface. Because the heat transfer coefficient changes upon going from laminar to turbulent flow 9, it is possible in this way to record any existing transition region over the entire surface.

The method extends much further, however! The method is generally applicable to any kind of surface around which a flow circulates, such as, for example, scaled models of automobiles, trains, and airplanes in wind tunnels. This method would also be applicable to the development of sports equipment (such as bicycle and motorcycle helmets, golf balls, etc.). This method could also be applied in the development of wind power plants (in particular in the development of rotors).

List of reference numbers

| Reference number | Description |
|---|---|
| 1 | surface around which a flow circulates |
| 3 | heat insulation layer |
| 5 | flash lamp |
| 7 | camera system |
| 9 | flow; laminar/turbulent |

1. A method for determining a transition point and/or for determining wall shear stresses on surfaces (1) around which a flow circulates by thermography, wherein the method comprises the steps:
providing a surface with a heat insulation layer (3) on the surface (1) around which a flow circulates;
circulating a flow around the surface (1) around which a flow is to circulate;
heating of the surface (1) around which a flow circulates;
contactless measurement of the radiation intensity emitted from the surface around which a flow circulates by a camera system (7);
determining at least one temperature decay coefficient on the surface (1) around which a flow circulates; and
determining the transition point and/or the wall shear stresses on the surface (1) around which a flow circulates,
and/or surface-area representation of the decay coefficients.

2. The method according to claim 1, wherein the surface has a functional layer applied to the heat insulation layer (3).

3. The method according to claim 1, further comprising the step:
determining reference values, wherein the radiation intensity emitted from the surface (1) around which a flow circulates is measured by a camera system (7) without circulating a flow around the surface (1) around which a flow is to circulate.

4. The method according to claim 3, further comprising the step:
determining the temperature decay coefficient on the surface (1) around which a flow circulates, wherein the reference values are subtracted from the measured values of emitted heat of the surface (1) around which a flow circulates with circulation around the surface around which a flow is to be circulated, or vice versa.

5. The method according to claim 1, wherein the surface (1) around which a flow circulates is a surface of a turbine rotor blade.

6. The method according to claim 1, wherein the surface (1) around which a flow circulates is a surface of a turbine stator blade.

7. The method according to claim 1, wherein the camera system (7) is an infrared camera system or has such an infrared camera system.

8. The method according to claim 7, wherein the infrared camera is combined with a boroscope or has such a boroscope.

9. The method according to claim 1, wherein the surface (1) around which a flow circulates is heated by a flash lamp (5) or by a laser.

10. The method according to claim 1, wherein the wall shear stresses are determined by the previously determined temperature decay coefficients.

11. The method according to claim 1, wherein emitted heat of the surface (1) around which a flow circulates is measured on the flow side of the surface (1) around which a flow circulates.

12. A measuring device for determining a transition point and/or for determining the wall shear stresses on surfaces (1) around which a flow circulates, wherein the measuring device is configured for carrying out the method steps of:
heating of the surface (1) around which a flow circulates;
contactless measuring of emitted heat from the surface (1) around which a flow circulates by a camera system (7);
determining at least one temperature decay coefficient on the surface (1) around which a flow circulates; and
determining the transition point and/or the wall shear stresses on the surface (1) around which a flow circulates,
and/or the qualitative representation of the heat transfer into the flow.
